(19) United States
(12) Patent Application Publication
(10) Pub. No.: US 2017/0345355 A1
(43) Pub. Date: Nov. 30, 2017

(54) DISPLAY DRIVING APPARATUS

(71) Applicant: Raydium Semiconductor Corporation, Hsinchu (TW)

(72) Inventors: SHANG-PING TANG, Zhubei City (TW); HUNG LI, Taipei City (TW); JUN-REN SHIH, Hsinchu City (TW)

(21) Appl. No.: 15/599,701

(22) Filed: May 19, 2017

Related U.S. Application Data
(60) Provisional application No. 62/342,229, filed on May 27, 2016.

(51) Int. Cl. G09G 3/20; G09G 3/36

(52) U.S. Cl. CPC G09G 3/2003; G09G 3/3611; G09G 3/3685; G09G 3/3607; G09G 2320/045; G09G 2320/0693; G09G 2320/0276

(57) ABSTRACT

A display driving apparatus is disclosed. The display driving apparatus includes a data processing unit, a first setting unit, a second setting unit, a mapping unit and a source driving unit. The data processing unit receives and processes an image data including data lines. The first setting unit generates a first setting signal corresponding to a first gamma value. The second setting unit generates a second setting signal corresponding to a second gamma value. The mapping unit maps the first gamma value and second gamma value to odd-numbered data lines and even-numbered data lines of the data lines respectively according to the first setting signal and second setting signal. The source driving unit outputs the first gamma value and second gamma value to odd-numbered display lines and even-numbered display lines of display lines of a display panel respectively.

### BACKGROUND OF THE INVENTION

### 1. Field of the Invention

This invention relates to a display, especially to a display driving apparatus applied to a display.

### 2. Description of the Prior Art

In general, users usually hope that the liquid crystal display can provide larger viewing angle. In order to achieve this goal, different liquid crystal arrangements and rotation directions can be designed on the same liquid crystal display panel, namely different liquid crystal domain designs.

For example, as shown in FIG. 1, in a currently used structure, liquid crystals LC of the odd-numbered display lines LOD and the even-numbered display lines LEV of the liquid crystal display panel are adjusted to have different rotation directions for providing larger viewing angle to the user. In addition, the arrangement of the electrodes E of the odd-numbered display lines LOD and the even-numbered display lines LEV is also different from that of the liquid crystals LC.

In practical applications, although different arrangements and rotation directions of the odd-numbered display lines LOD and the even-numbered display lines LEV can increase the viewing angle, since the lights emitted by the odd-numbered display lines LOD and the even-numbered display lines LEV reaching the eye of the user will have different lightness, the user will feel different about the odd-numbered display lines LOD and the even-numbered display lines LEV; therefore, some fine stripes will occur on the liquid crystal display panel.

### SUMMARY OF THE INVENTION

Therefore, the invention provides a display driving apparatus to solve the above-mentioned problems in the prior arts.

An embodiment of the invention is a display driving apparatus. In this embodiment, the display driving apparatus is coupled to a display panel and the display driving apparatus drives the display panel. The display panel includes a plurality of display lines. The display driving apparatus includes a data processing unit, a first setting unit, a second setting unit, a mapping unit and a source driving unit. The data processing unit receives and processes an image data including a plurality of data lines. The first setting unit generates a first setting signal corresponding to a first gamma value. The second setting unit generates a second setting signal corresponding to a second gamma value. The mapping unit is coupled to the data processing unit, the first setting unit and the second setting unit and used to map the first gamma value and the second gamma value to odd-numbered data lines and even-numbered data lines of the data lines respectively according to the first setting signal and the second setting signal. The source driving unit is coupled between the mapping unit and the display panel, for outputting the first gamma value and the second gamma value to the odd-numbered display lines and the even-numbered display lines of the display lines of the display panel respectively.

In an embodiment, the first gamma value and the second gamma value are different.

In an embodiment, the odd-numbered data lines and the even-numbered data lines of the plurality of data lines are mapped by different gamma values respectively.

In an embodiment, each of the plurality of display lines of the display panel includes a plurality of liquid crystal units. The odd-numbered display lines and the even-numbered display lines of the plurality of display lines are mapped by different gamma values respectively, so that the plurality of liquid crystal units of the odd-numbered display lines and the plurality of liquid crystal units of the even-numbered display lines have different rotation angles.

In an embodiment, lightness difference between the odd-numbered data lines displayed by the odd-numbered display lines and the even-numbered data lines displayed by the even-numbered display lines is compensated accordingly to avoid the occurrence of fine stripes on the display panel.

In an embodiment, the display driving apparatus further includes a multiplexer. The multiplexer is coupled among the first setting unit, the second setting unit and the mapping unit and used for receiving the first setting signal and the second setting signal respectively and selectively outputting the first setting signal or the second setting signal to the mapping unit according to a count signal.

In an embodiment, when the count signal counts an odd number, the multiplexer outputs the first setting signal to the mapping unit; when the count signal counts an even number, the multiplexer outputs the second setting signal to the mapping unit.

In an embodiment, the display driving apparatus further includes a counter. The counter is coupled to the multiplexer and used for providing the count signal to the multiplexer.

Compared to the prior art, the display driving apparatus of the invention can not only achieve the effect of increasing viewing angle, but also effectively avoid the different visional feelings of the user about the odd-numbered display lines and the even-numbered display lines of the liquid crystal display panel; therefore, fine stripes will not occur on the display panel, so that the display quality of the liquid crystal display and the satisfaction of the user can be enhanced.

The advantage and spirit of the invention may be understood by the following detailed descriptions together with the appended drawings.

### BRIEF DESCRIPTION OF THE APPENDED DRAWINGS

FIG. 1 illustrates a schematic diagram of the conventional liquid crystal display panel having different liquid crystal arrangements and rotation directions.

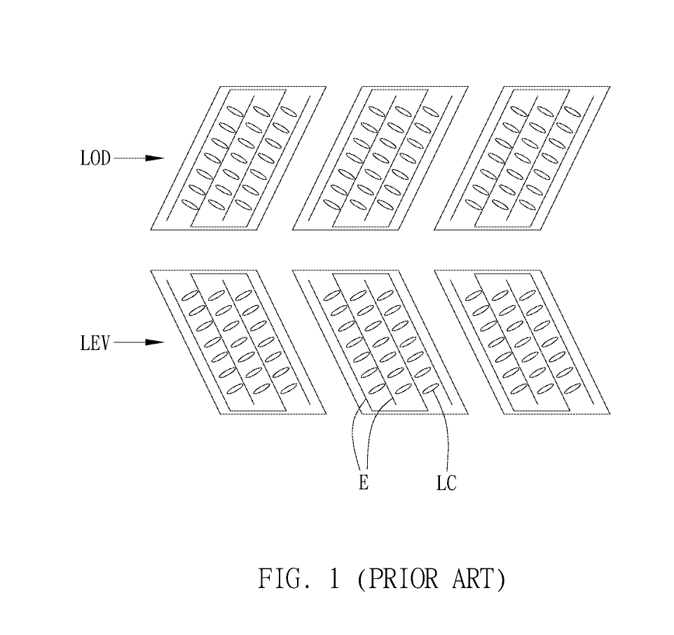

FIG. 2 illustrates a functional block diagram of the display driving apparatus in a preferred embodiment of the invention.

FIG. 3 illustrates a schematic diagram of adjusting upward or downward the gamma curves of the odd-numbered data lines and the even-numbered data lines.

### DETAILED DESCRIPTION OF THE INVENTION

A preferred embodiment of the invention is a display driving apparatus. In this embodiment, the display driving apparatus can be a source driver which is coupled to a display panel and drives a plurality of display lines of the display panel, but not limited to this.

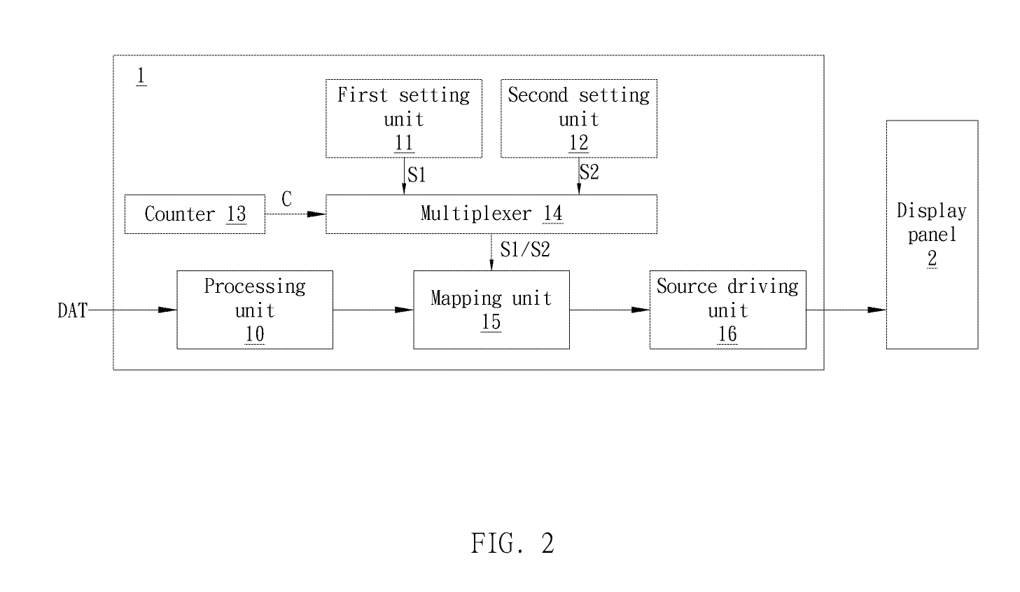

Please refer to FIG. 2. FIG. 2 illustrates a functional block diagram of the display driving apparatus in this embodiment. As shown in FIG. 2, the display driving apparatus 1 is coupled to the display panel 2 including a plurality of display lines (not shown in the figures).

In this embodiment, the display driving apparatus 1 includes a data processing unit 10, a first setting unit 11, a second setting unit 12, a counter 13, a multiplexer 14, a mapping unit 15 and a source driving unit 16. Wherein, the data processing unit 10 is coupled to the mapping unit 15; the first setting unit 11 and the second setting unit 12 are coupled to the multiplexer 14; the multiplexer 14 is coupled to the mapping unit 15; the mapping unit 15 is coupled to the source driving unit 16; the source driving unit 16 is coupled to the display panel 2.

When the data processing unit 10 receives an image data DAT, the image data DAT will be performed an image process by the data processing unit 10 and then outputted to the mapping unit 15. Wherein, the image data DAT includes a plurality of data lines.

The first setting unit 11 and the second setting unit 12 are used to generate a first setting signal S1 corresponding to a first gamma value and a second setting signal S2 corresponding to a second gamma value to the multiplexer 14 respectively. It should be noticed that the first setting unit 11 and the second setting unit 12 are used to set the gamma values of odd-numbered data lines and even-numbered data lines of the data lines of the image data DAT respectively. That is to say, the gamma values of the odd-numbered data lines and the even-numbered data lines of the image data DAT in the invention are set by different setting units (e.g., the first setting unit 11 and the second setting unit 12) respectively, so that the lightness of the odd-numbered data lines and the even-numbered data lines of the image data DAT can be differently adjusted respectively.

Then, when the multiplexer 14 receives the first setting signal S1 and the second setting signal S2 from the first setting unit 11 and the second setting unit 12 respectively, the multiplexer 14 will selectively output the first setting signal S1 or the second setting signal S2 to the mapping unit 15 according to a count signal C provided by the counter 13.

It should be noticed that when the count signal C counts an odd number, the multiplexer 14 will output the first setting signal S1 to the mapping unit 15; when the count signal C counts an even number, the multiplexer 14 will output the second setting signal S2 to the mapping unit 15.

For example, when the count signal C counts 1 which is an odd number, the multiplexer 14 will output the first setting signal S1 to the mapping unit 15 according to the count signal C provided by the counter 13.

Similarly, when the count signal C counts 2 which is an even number, the multiplexer 14 will output the second setting signal S2 to the mapping unit 15 according to the count signal C provided by the counter 13, and so on.

When the mapping unit 15 receives the first setting signal S1 corresponding to the odd-numbered data lines from the multiplexer 14, the mapping unit 15 will correspondingly map the first gamma value to the odd-numbered data lines of the plurality of data lines.

Similarly, when the mapping unit 15 receives the second setting signal S2 corresponding to the even-numbered data lines from the multiplexer 14, the mapping unit 15 will correspondingly map the second gamma value to the even-numbered data lines of the plurality of data lines.

It should be noticed that since the first gamma value and the second gamma value are different, the odd-numbered data lines and the even-numbered data lines of the plurality of data lines will be mapped by different gamma values to have different lightness. Therefore, the different first gamma value and second gamma value can be used to adjust the lightness of the gamma curves of the odd-numbered data lines and the even-numbered data lines respectively.

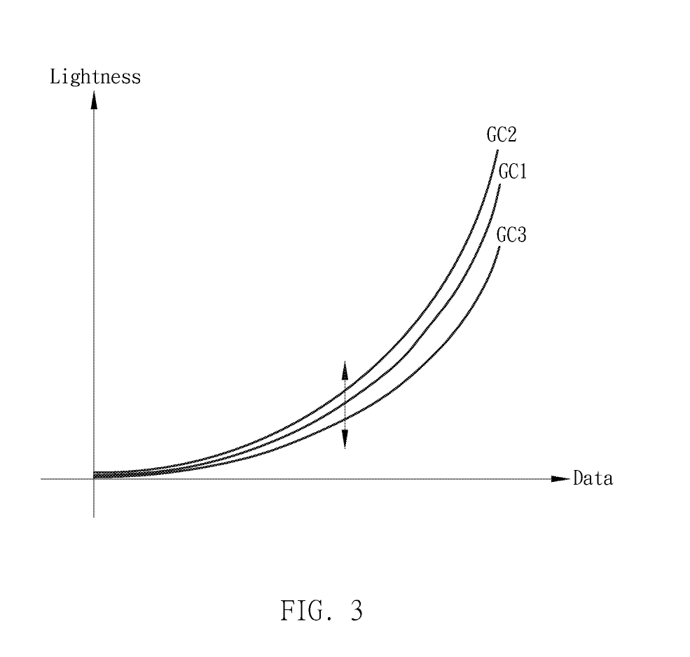

For example, as shown in FIG. 3, if the original gamma curve of a data line is the first gamma curve GC1, no matter the data line is an odd-numbered data line or an even-numbered data line, the first gamma curve GC1 can be adjusted upward as the second gamma curve GC2 having higher lightness or adjusted downward as the third gamma curve GC3 having lower lightness based on practical needs.

Then, the source driving unit 16 will output the first gamma value and the second gamma value to odd-numbered display lines and even-numbered display lines of the display lines of the display panel 2 respectively. That is to say, the source driving unit 16 will output the first gamma value to the odd-numbered display lines including the first display line, the third display line, the fifth display line, . . . of the display panel 2 respectively and the source driving unit 16 will output the second gamma value to the even-numbered display lines including the second display line, the fourth display line, the sixth display line, . . . of the display panel 2 respectively.

It should be noticed that since each display line of the display panel 2 includes liquid crystal units, as stated above, when the odd-numbered display lines and the even-numbered display lines of the display panel 2 are mapped by different gamma values (e.g., the first gamma value and the second gamma value), the liquid crystal units on the odd-numbered display lines and the liquid crystal units on the even-numbered display lines will have different rotation angles. Thus, the lightness difference between the odd-numbered data lines of the image data DAT displayed by the odd-numbered display lines of the display panel 2 and the even-numbered data lines of the image data DAT displayed by the even-numbered display lines of the display panel 2 will be compensated accordingly, so that the lights emitted by the odd-numbered display lines and the even-numbered display lines of the display panel 2 will have almost the same lightness. Therefore, the user will feel almost the same about the image data DAT displayed by the odd-numbered display lines and the even-numbered display lines of the display panel 2, and there will be no fine stripes occurred on the display panel 2.

Compared to the prior art, the display driving apparatus of the invention can not only achieve the effect of increasing viewing angle, but also effectively avoid the different visional feelings of the user about the odd-numbered display lines and the even-numbered display lines of the liquid crystal display panel; therefore, fine stripes will not occur on the display panel, so that the display quality of the liquid crystal display and the satisfaction of the user can be enhanced.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A display driving apparatus, coupled to a display panel and driving the display panel, the display panel comprising a plurality of display lines, the display driving apparatus comprising:
a data processing unit, for receiving and processing an image data, wherein the image data comprising a plurality of data lines;
a first setting unit, for generating a first setting signal corresponding to a first gamma value;
a second setting unit, for generating a second setting signal corresponding to a second gamma value;
a mapping unit, coupled to the data processing unit, the first setting unit and the second setting unit, for mapping the first gamma value and the second gamma value to odd-numbered data lines and even-numbered data lines of the plurality of data lines according to the first setting signal and the second setting signal respectively; and
a source driving unit, coupled between the mapping unit and the display panel, for outputting the first gamma value and the second gamma value to odd-numbered display lines and even-numbered display lines of the plurality of display lines of the display panel respectively.

2. The display driving apparatus of claim 1, wherein the first gamma value and the second gamma value are different.

3. The display driving apparatus of claim 2, wherein the odd-numbered data lines and the even-numbered data lines of the plurality of data lines are mapped by different gamma values respectively.

4. The display driving apparatus of claim 2, wherein each of the plurality of display lines of the display panel comprises a plurality of liquid crystal units, the odd-numbered display lines and the even-numbered display lines of the plurality of display lines are mapped by different gamma values respectively, so that the plurality of liquid crystal units of the odd-numbered display lines and the plurality of liquid crystal units of the even-numbered display lines have different rotation angles.

5. The display driving apparatus of claim 4, wherein lightness difference between the odd-numbered data lines displayed by the odd-numbered display lines and the even-numbered data lines displayed by the even-numbered display lines is compensated accordingly to avoid the occurrence of fine stripes on the display panel.

6. The display driving apparatus of claim 1, further comprises:
a multiplexer, coupled among the first setting unit, the second setting unit and the mapping unit, for receiving the first setting signal and the second setting signal respectively and selectively outputting the first setting signal or the second setting signal to the mapping unit according to a count signal.

7. The display driving apparatus of claim 6, wherein when the count signal counts an odd number, the multiplexer outputs the first setting signal to the mapping unit; when the count signal counts an even number, the multiplexer outputs the second setting signal to the mapping unit.

8. The display driving apparatus of claim 6, further comprises:
a counter, coupled to the multiplexer, for providing the count signal to the multiplexer.
